(19) United States
(12) Patent Application Publication
(10) Pub. No.: US 2018/0067381 A1
(43) Pub. Date: Mar. 8, 2018

(54) INTERACTIVE EVENT PHOTOGRAPHY KIOSK

(71) Applicant: Aflatoon AFLATOONI, Toronto, Ontario (CA)

(72) Inventor: Aflatoon AFLATOONI, Toronto, Ontario (CA)

(21) Appl. No.: 15/545,505

(22) PCT Filed: Oct. 22, 2015
(86) PCT No.: PCT/CA2015/051079

§ 371 Date: Jul. 21, 2017

(51) Int. Cl. G03B 17/50; G03B 17/02; H04N 1/00; H04L 29/08

(52) U.S. Cl. CPC G03B 17/50; G03B 17/02; G06F 3/0416; H04L 67/025; H04N 1/00161; H04N 1/0019

(57) ABSTRACT

A portable interactive photo kiosk comprising a weighted base section comprising a bottom surface for abutting support on a floor surface and a top surface defining a bore for rotatably receiving a rotational shaft; a body section housing a drive mechanism to control oscillating rotation of the body section relative to the base section between a first angular end position and a second angular end position; a display comprising a processor and interactive touch screen display coupled to a top portion of the body section; a camera communicative with the processor, a printer housed within the body section and communicative with the processor and a proximity sensor communicative with the processor for sending a control signal to stop oscillating rotation of the body section. Networked systems and methods incorporating the same are also described.

### BACKGROUND OF THE INVENTION

### Field of the Invention

The present invention relates to event photography, and more particularly to interactive event photography kiosks.

### Description of the Related Art

Photography is an integral component of social events such as weddings, engagements, birthdays, marriage anniversaries, bar mitzvahs, corporate Christmas parties, product launch expositions, annual general meetings, trade shows, and the like. Generally, any event that is booked at any banquet hall, convention hall or any other professional exhibition venue includes consideration of photography to capture images of the event proceedings and participants.

Hiring of professional photographers to circulate and capture images often accompanies staging of social events. Over the past decade the installation of interactive photography kiosks at events has gained popularity. The photography kiosk can serve a complimentary function to the professional photographer. The photography kiosk can capture images for those who wish to pose for portraits freeing the professional photographer to circulate and capture unrehearsed images. Furthermore, the interactive photography kiosk can serve an entertainment function as participants who wish to pose for portraits can then interact with a computer controlled display interface to select various image capture, editing or processing options and various image printing or image delivery options.

The entertainment function of interactive photo kiosks includes components of occupying a small footprint to be aesthetically attractive and features to stop and engage passing foot traffic. Current, interactive photo kiosks have limited features to stop and engage passing foot traffic. Another disadvantage of current interactive photo kiosks is that photographs are captured with background screens. As such placement of current kiosks faces a dilemma of either placing a screen in an area with diminished foot traffic and consequent reduction in engagement of event participants or placing the screen in a location that intrudes upon foot traffic and may annoy event participants.

Accordingly, there is a continuing need for alternative interactive event photography kiosks.

### SUMMARY OF THE INVENTION

In an aspect there is provided a portable interactive photo kiosk comprising:

a weighted base section comprising a bottom surface for abutting support on a floor surface and a top surface defining a bore for rotatably receiving a rotational shaft;

a body section housing a drive mechanism to control oscillating rotation of the body section relative to the base section between a first angular end position and a second angular end position;

a display comprising a processor and an interactive touch screen display coupled to a top portion of the body section;

a camera communicative with the processor,

a printer housed within the body section and communicative with the processor; and

a proximity sensor communicative with the processor for sending a control signal to stop oscillating rotation of the body section.

In another aspect there is provided an interactive photo kiosk comprising:

a weighted base section comprising a bottom surface for abutting support on a floor surface;

a body section housing a drive mechanism to control oscillating rotation of the body section relative to the base section between a first angular end position and a second angular end position;

a display, a camera, a processor and a user interface coupled to a top portion of the body section; and

a sensor communicative with the drive mechanism for sending a control signal to stop oscillating rotation of the body section.

### BRIEF DESCRIPTION OF THE DRAWINGS

FIG. 1 shows a front plan view of an interactive photo kiosk;

FIG. 2 shows a block schematic view of operational components of the interactive photo kiosk shown in FIG. 1 incorporated within a networked system to monitor, support and/or control a plurality of interactive photo kiosks;

FIG. 3 shows a top plan view of the interactive photo kiosk in a static position;

FIG. 4 shows a top plan view of the interactive photo kiosk in rotating oscillation;

FIG. 5 shows a top plan view of the interactive photo kiosk rotating with an activated proximity sensor;

FIG. 6 shows a top plan view of the interactive photo kiosk after detecting a subject and arresting rotation;

FIG. 7 shows a side plan view of a variant of the interactive photo kiosk shown in FIG. 1; and

FIG. 8 shows a front plan view of another variant of the interactive photo kiosk shown in FIG. 1.

### DETAILED DESCRIPTION OF PREFERRED EMBODIMENTS

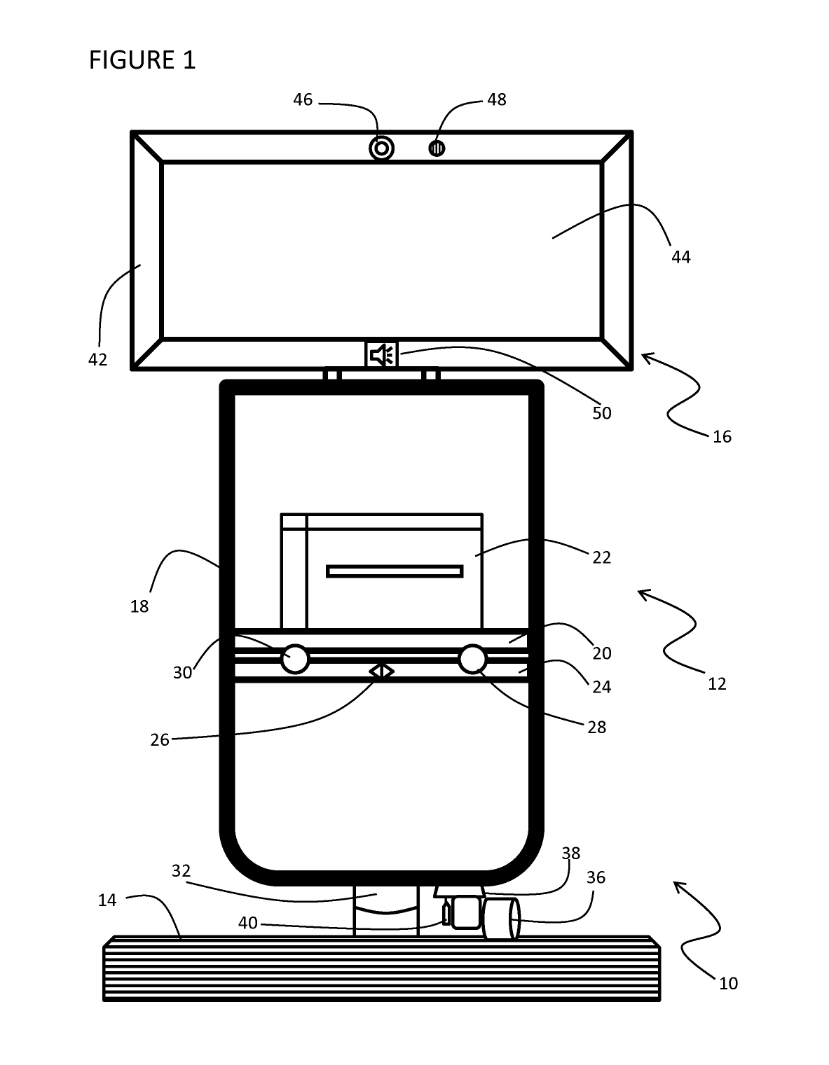

Now referring to the drawings, FIG. 1 shows a front plan view of an interactive photo kiosk 10 comprising three reversibly attachable components: a central body section 12 bound by a frame 18 having substantially planar top and bottom ends joined by substantially planar first and second sides extending longitudinally therebetween, a weighted base 14 pivotally coupled to the bottom end of frame 18 and an electronic monitor 16 mounted to the top end of frame 18. During installation of the interactive photo kiosk 10, the central body section 12 is reversibly attached to the weighted base 14 and the electronic monitor 16 at its bottom and top ends, respectively, while during transport (eg., shipping) these three components can be readily detached and packaged as three separate components.

When the interactive photo kiosk 10 is installed and ready for operation, frame 18 is oriented so that its top and bottom ends are substantially parallel to a floor surface. In this orientation the top and bottom ends of frame 18 define a horizontal and lateral dimension and the first and second sides of frame 18 define a vertical and longitudinal dimension. A shelf 20 positioned midway between and aligned parallel the top and bottom ends of frame 18 extends horizontally between the first and second sides of frame 18 and supports printer 22. A mounting bar 24 is coupled to shelf 20 and aligned parallel to shelf 20. The mounting bar 24 houses a proximity sensor 26 and first and second photography lights 28 and 30. The proximity sensor 26 is centrally located within frame 18 and is generally aligned with the vertical/longitudinal axis of frame 18. The first and second photography lights 28 and 30 are positioned at opposing peripheral locations of mounting bar 24 within frame 18.

Weighted base 14 is heavier than the combined weight of frame 18 and electronic monitor 16 so as to provide stability and a low center of gravity for the interactive photo kiosk 10. Weighted base 14 is devoid of electric wiring and electric components to facilitate quick and reversible attachment of frame 18 to weighted base 14.

Weighted base 14 is bound by substantially planar top, bottom and side surfaces. The bottom surface of weighted base 14 receives abutting support from the floor surface on which it is placed, while the top surface defines an aperture (not shown) communicating with a bore (not shown) to receive a double bearing shaft 32 for pivotal connection of frame 18 to weighted base 14. The double bearing shaft 32 is slidably received within the bore defined in weighted base 14. The shaft component of the double bearing shaft 32 is freely rotatable within the bore of weighted base 14, allowing frame 18 to rest on and rotate with the double bearing component of double bearing shaft 32. The pivotal connection between the bottom end of frame 18 and the top end of weighted base 14 provides a single degree of freedom of rotational motion. The rotational axis of this degree of freedom is substantially co-axial with the vertical axis of symmetry of frame 18. A suitable drive mechanism is used to provide motive power to control the rotational motion. Motor 38 housed at the bottom end of frame 18 drives a wheel/roller 36 that frictionally engages the top surface of weighted base 14. Motor 38 extends from the bottom end of frame 18 and rotates a drive shaft (not shown) that is coupled to and rotates wheel/roller 36. The axis of rotation of the drive shaft is substantially parallel to the top surface of weighted base 14 and the radius of wheel/roller 36 is approximately equal to the distance between the drive shaft and the top surface of the weighted base 14. Friction contact between wheel/roller 36 and the top surface is sufficient to drive rotation of frame 18 on double bearing shaft 32. Friction contact between wheel/roller 36 and the top surface is also sufficient to prevent unintended rotation of frame 18 on double bearing shaft 32 by manual pressure applied by an event participant. Mounting of motor 38 at the bottom end of frame 18 may include resilient spacers such as compression springs so as to provide a biasing force of wheel/roller 36 against the top surface of the weighted base 14 and increase the frictional contact. The resilient spacers such as compression springs may be adjustable. At least one limit switch 40 controls the drive mechanism to reverse direction of the motor 38 at first and second predetermined angular positions. The limit switch 40 can interact with first and second markers coupled to the top surface of the weighted base 14. The first and second markers correspond to the first and second predetermined angular positions, respectively. The first and second markers may be any suitable marker that can engage a limit switch including mechanical, magnetic, or optical markers. As such, the frame 18 can be made to oscillate by rotation between a first predetermined angular position and a second predetermined angular position.

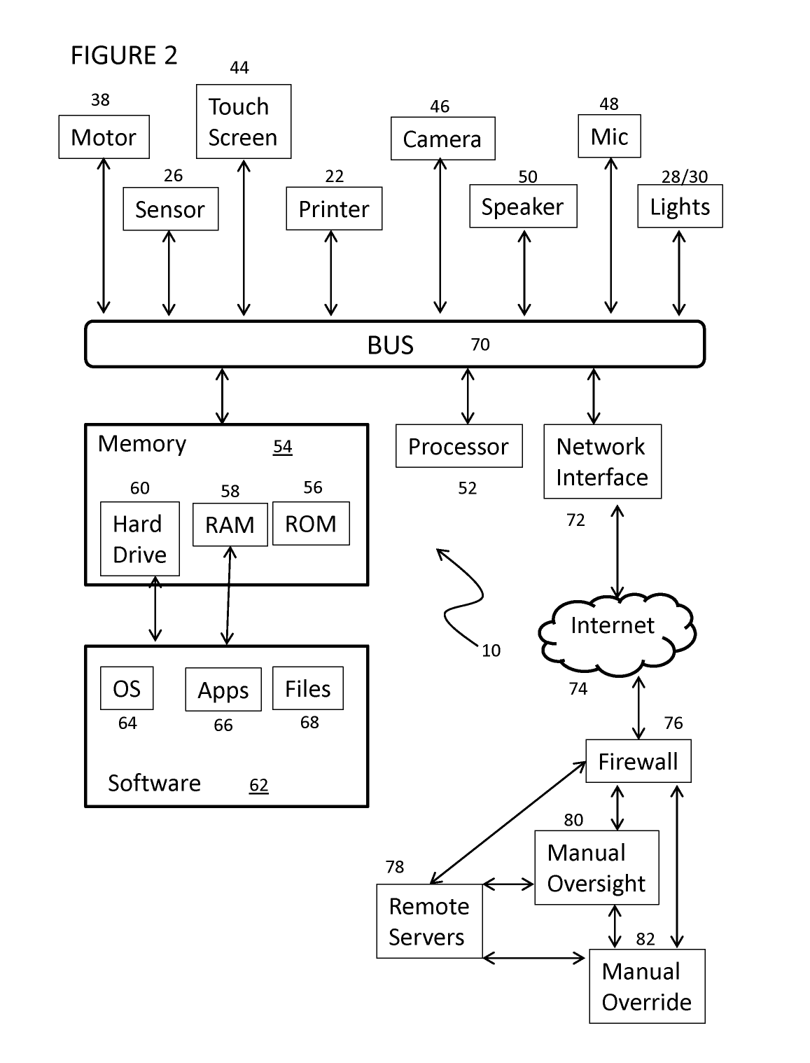

Electronic monitor 16 is mounted to the top end of frame 18 with a reversibly attachable coupling. The electronic monitor comprises a casing 42 that houses a touch screen display 44, a camera 46, a microphone 48 and an audio speaker 50. The touch screen display 44, the camera 46, the microphone 48, the audio speaker 50, the printer 22, the photography lights 28 and 30, the proximity sensor 26 and the motor 38 are all operably communicative with at least one processor 52 (shown in FIG. 2) to coordinate rotational motion with other various functions of lights, sounds and image capture to provide engagement of event participants and desired photos.

FIG. 2 is a block diagram illustrating communicative linking of operational components of the interactive photo kiosk 10 shown in FIG. 1, connected to a system that can monitor and communicate with a plurality of such interactive photo kiosks installed at a plurality of different locations. The at least one processor 52 can send and/or receive signals from any combination of the touch screen display 44, the camera 46, the microphone 48, the audio speaker 50, the printer 22, the photography lights 28 and 30, the proximity sensor 26 and the motor 38 by communicative coupling to data bus 70. The processor can access a local storage system 54 which can include any desired form of memory including non-volatile memory such as Read Only Memory 56 (eg., ROM, EPROM, EEPROM, Flash ROM) or, volatile memory such as Random Access Memory 58 (eg., RAM, DRAM, SRAM, TRAM, ZRAM), and non-volatile direct-access auxiliary data storage devices such as magnetic memory hard disk drive(s) 60 and/or optical drives (not shown). Through the bus 70 connection, the processor 52 can access any manner of programmable operational instructions 62 such as an operating system 64, software applications 66 and application files and data 68 that are stored on hard drive 60 and executed using RAM 58. The processor may also communicate with a network interface 72 that provides an Internet connection and allows processor 52 to communicate over the Internet 74 with remote server(s) 78 that can provide additional operational and data management capacity. Additionally, an Internet connection can be used to simultaneously monitor and control a plurality of interactive photo kiosks 10 installed at different locations. The monitoring capacity can include options for human operator oversight 80 and human operator override 82 with respect to one or more of the linked interactive photo kiosks 10. Established security devices and protocols 76 may be implemented to prevent unauthorized access to Internet communication with the interactive photo kiosk 10.

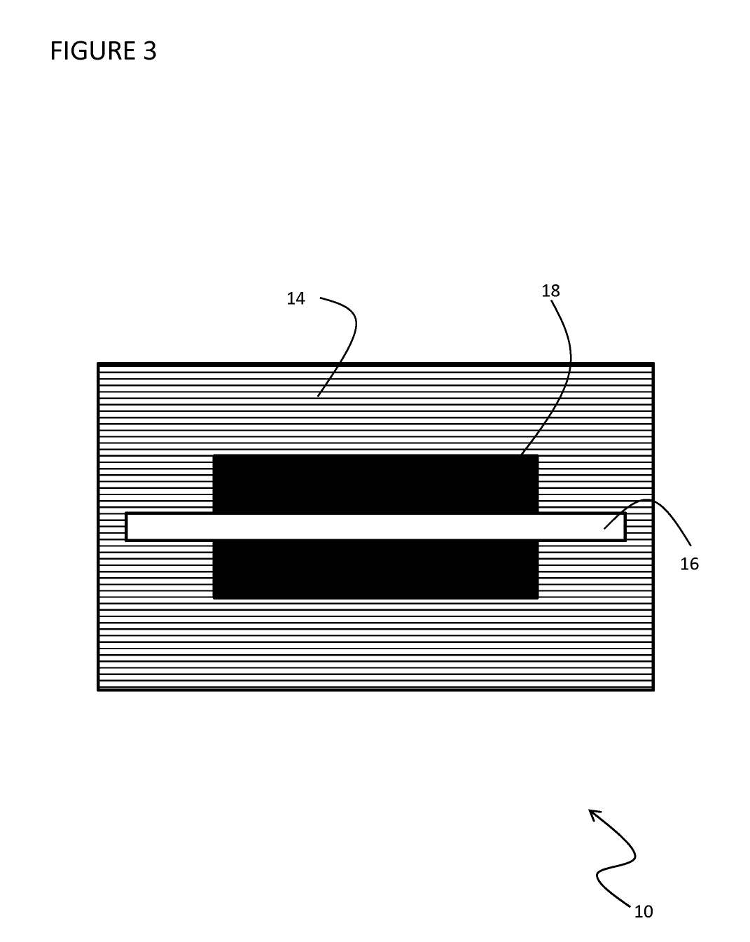

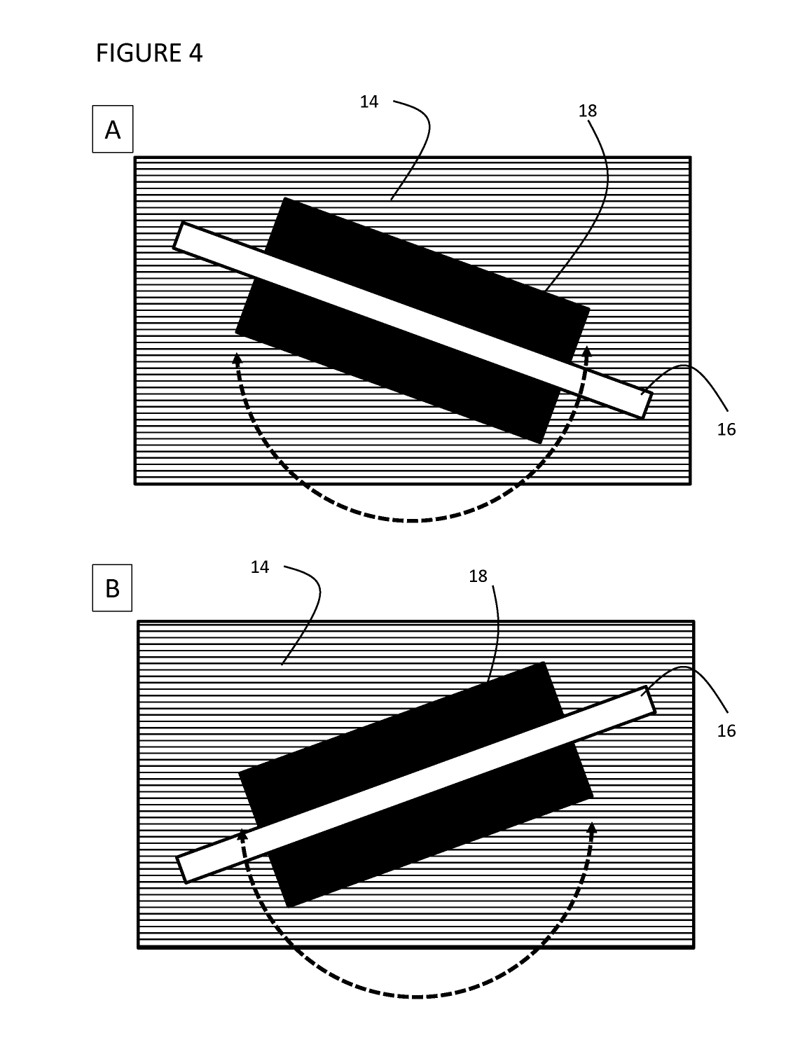

Illustrative operational advantages of the interactive photo kiosk 10 can be described with reference to FIGS. 3 to 6 which each show a top plan view of the interactive photo kiosk 10 at various stages of operation. FIG. 3 shows the interactive photo kiosk 10 in a static mode with no rotation of frame 18 on its vertical axis of rotation with weighted base 14. FIG. 4 shows the frame 18 rotating on its vertical axis of rotation with respect to weighted base 14, mediated by the double bearing shaft 32 coupling of frame 18 and weighted base 14 and a drive mechanism to provide motive force to control rotation. FIG. 4A shows clockwise rotation of frame 18 on the double bearing shaft 32 vertical axis until reaching a first predetermined angular position. At the first predetermined angular position the drive mechanism reverses polarity and directs counterclockwise rotation of frame 18 (FIG. 4B) until it reaches a second predetermined angular position. At least one limit switch 40 interacts with a pair of markers coupled to the top surface of the weighted base 14 to control the drive mechanism and reverse direction of the motor 38 at first and second predetermined angular positions. As such, the frame 18 can be made to oscillate by rotation from a first predetermined angular position (FIG. 4A) to a second predetermined angular position (FIG. 4B) and the back to the first predetermined angular position (FIG. 4A) in an automated continuous cycle.

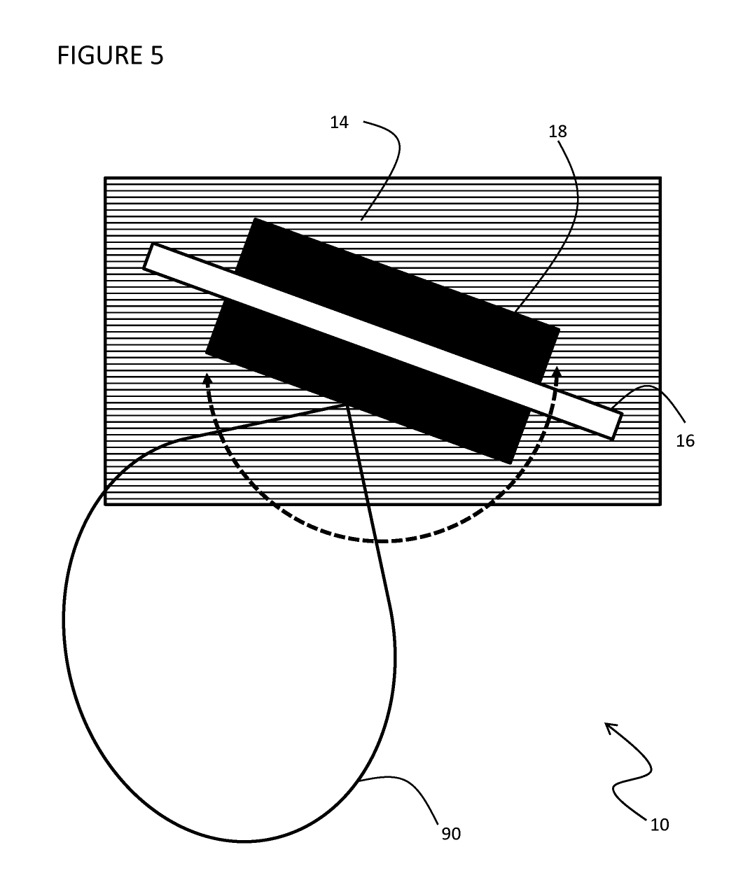

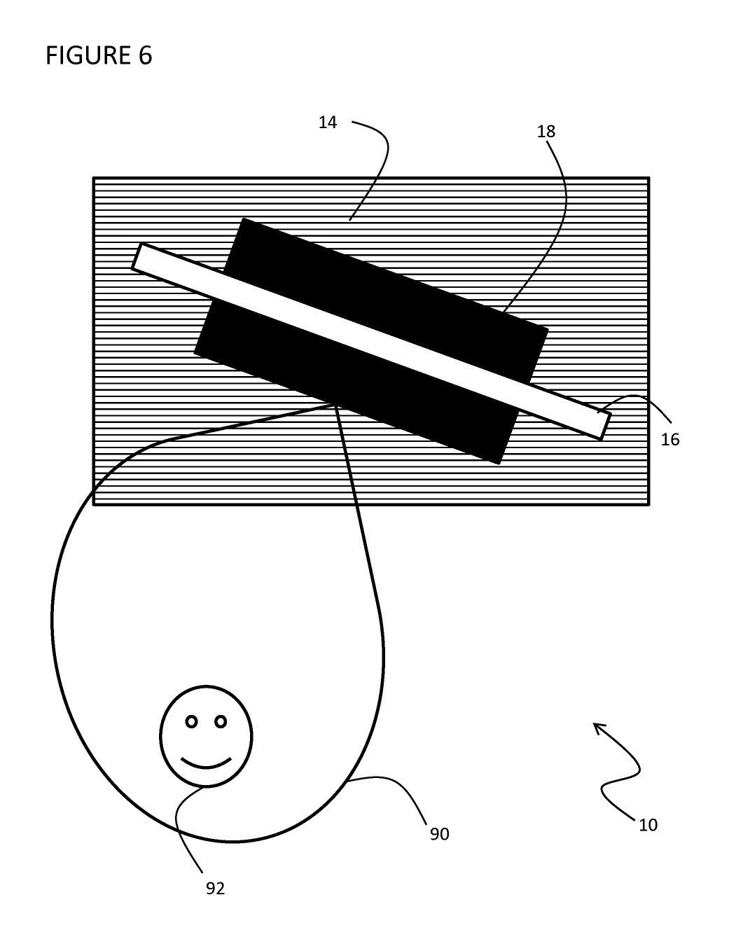

During oscillating rotation the proximity sensor 26 is activated and generates a detection field 90 that remains active throughout the rotation (FIG. 5). Once a subject such as an event participant 92 is detected (FIG. 6) a detection signal is communicated to processor 52 which in turn sends a control signal to motor 38 to stop the drive mechanism and stop rotation. At this point processor 52 proceeds to execute preprogrammed instructions for engaging the event participant and prompting selections for image capture. As part of the image capture process the processor 52 may analyze the background of the event participant for suitability by determining standard photography parameters such as brightness, color, movement, and the like, and if unsuitable may prompt the event participant to another location by rotation of frame 18 and electronic monitor 16 to an angular position providing a background suitable for image capture. In another example, an angular position designated for image capture may be determined at the time of installation and may include a background screen setup. The rotational degree of freedom allows the frame 18 to rotate from a stopped angular position of engagement with an event participant to a third angular position suited for image capture. The third angular position may be predetermined or may be determined based on analysis of image data captured at different points during a rotational scan from the first predetermined angular position to the second predetermined angular, or may be a combination of predetermined positions moderated by analysis of on-sight image data. The third angular position suited for image capture may be within the range defined by the first and second predetermined angular positions or may be outside this range depending on a desired implementation.

Several illustrative variants have been described above. Further variants and modifications are described below. Moreover, guiding relationships for configuring variants and modifications are also described below. Still further variants and modifications are contemplated and will be recognized by the person of skill in the art. It is to be understood that guiding relationships and illustrative variants or modifications are provided for the purpose of enhancing the understanding of the person of skill in the art and are not intended as limiting statements.

The function of the weighted base 14 is to provide stability and to lower the center of gravity of the interactive photo kiosk 10. The weighted base 14 can accommodate various sizes and shapes provided the weighted base provides a balanced and stable platform for supporting frame 18 and electronic monitor 16. The weighted base 14 may comprise a planar bottom surface to receive abutting support from a floor surface. Alternatively, the weighted base 14 may comprise feet that abut the floor surface. The feet may be adjustable to modify vertical distance from the bottom of the weighted base 14 to compensate for any gradient of the floor surface. The weighted base will typically have a weight that is equal to or greater than the combined weight of frame 18 and electronic monitor 16. To facilitate quick installation or decoupling of the interactive photo kiosk 10 the weighted base 14 may be devoid of electric wiring and electric components.

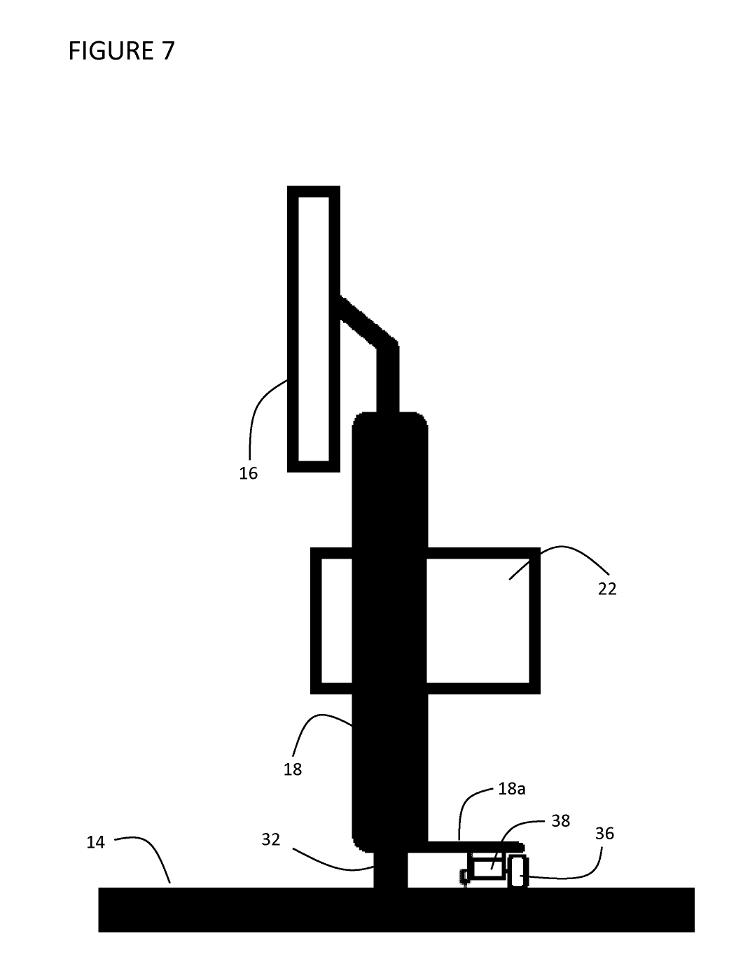

Additional stability of the frame 18 may be provided by connecting the drive mechanism to an arm 18a extending backwards from the bottom end of the frame 18 as illustrated in FIG. 7 showing a side plan view of a variant of the interactive photo kiosk shown in FIG. 1. The arm 18a extending backwards counteracts the most probable destabilizing occurrence—unintentional pressure applied to the front surface of the electronic monitor and or the frame by an event participant. Typically the arm 18a will be substantially perpendicular to frame 18 and substantially parallel to the top surface of the weighted base 14. The motor 38 and wheel/roller 36 may be mounted to a bottom surface of the arm 18a instead of the bottom end of frame 18. Alternatively, a supportive non-motorized roller may be attached to arm 18a while a motorized roller is attached to the bottom end of frame 18.

Frame 18 can be made of any desired material and any desired shape. Typically, frame 18 will be made of a light sturdy material so as to facilitate a weight ratio that favours the weighted base 14. The shape of frame 18 will typically have a lateral dimension that is smaller than the corresponding lateral dimension of the weighted base. Additionally, the lateral dimension of the frame 18 may be sized so that during rotation the sides of frame 18 fit within the footprint defined by the weighted base 14. The frame can be modified to include compartments, shelves, brackets, struts and the like to house and support any desired combination of operational components.

Any convenient pivot joint may be used to support rotational motion between the frame 18 and the weighted base 14. Any suitable drive mechanism may be used to control rotation. First and second predetermined angular positions that limit rotation of frame 18 may be any desired positions that are suited for a specific implementation including symmetric or asymmetric limits with reference to a central position (as shown in FIG. 3) of the frame 18 with the weighted base 14. Range and speed of oscillation between first and second angular positions will be sufficient to attract attention of passing foot traffic. Typically, the range of oscillation will be at least 20 degrees. Typically, the speed of oscillation will be at least 20 degrees per minute. The pivot joint and its vertical axis of rotation will typically be aligned with the axis of symmetry of the frame 18 and the weighted base 14. However, eccentric positioning of the pivot joint with respect to the axis of symmetry of the frame 18 and/or the weighted base 14 may be accommodated.

Any conventional drive mechanism may be employed including AC motors, DC motors, step motors, direct drive motors, belt drive motors and the like. The pivot joint and drive mechanism may be combined with direct drive motors. For example, a direct drive motor may power a drive shaft that slides into a receiving bore formed in the weighted base with a friction and static fit so that frame 18 rotates on a platform provided by the direct drive motor. However, the motor configuration shown in the drawings provides a stability benefit in that it is mounted eccentric to the pivot joint. Eccentric mounting of a motor to an arm 18a extending backward from the frame 18 as shown in FIG. 7 provides an even greater stability benefit.

The range of oscillation may be modified to suit a desired location. For example, when installed in the corner of a room the range of oscillation will typically be less than 90 degrees. When installed in front of a straight wall the range of oscillation will typically be less than 180 degrees. When installed in a corner of two intersecting hallways the range of oscillation will typically be less than 270 degrees. Range of oscillation may frequently be less than the physical space provided by a particular installation, as making use of a full range of oscillation may not be conducive to attracting and engaging passing foot traffic of event participants. Generally, a stop and change of motion is known to be a better tactic for attracting attention of an event participant, rather than continuous motion in a single direction. As such, the range of oscillation may be shortened to increase the number of stops and changes of direction per unit time. The limits of the range of oscillation may be adjustable by adjustment of markers that interact with limit switches.

The speed of oscillation may be modified depending on a specific implementation. For example, speed of oscillation may be different between a corporate party and a bar mitzvah. Generally, speed of oscillation may be modified to be fast enough to attract and engage passing foot traffic of event participants, while being slow enough to avoid intimidating event participants. Speed may be modulated or maintained at a constant through the range of oscillation as desired. Speed of oscillation will typically range between 1 degree per second and 30 degrees per second. In certain examples, speed of oscillation will range between 2 degrees per second and 15 degrees per second. When a predetermined angular position for image capture is used, the speed to move between a position of engagement with an event participant to the predetermined angular position for image capture will typically be faster than the speed of oscillation between first and second predetermined angular positions.

Additional pivot joint(s) may optionally be used. For example, a pivot joint defining a horizontal axis of rotation may be used to couple electronic monitor 16 to frame 18 to angle the electronic monitor 16. Control of rotation may be manual or mediated by a drive mechanism.

Electronic operational components may be housed within the electronic monitor 16, within the frame 18, or distributed within both the electronic monitor 16 and the frame 18. However, the weighted base 14 will typically be devoid of electronic operational components and electrical wiring so as to facilitate transport and reversible assembly of the interactive photo kiosk.

The electronic monitor may be coupled to any convenient surface of the frame 18, including inside of frame 18. The frame 18 and the electronic monitor 16 may be replaced by a single integrated unit. Whether coupled to an interior surface or exterior surface of frame 18, electronic monitor 16 will typically be coupled at or proximal to a top end of frame 18.

All or part of the frame may be composed of tubular structures that can house electric wiring and/or electronic operational components such as lights, cameras, spreakers.

The proximity sensor 26 may be any conventional sensor designed to detect a human presence. Sensors detecting motion, heat, capacitance, pressure and the like may be accommodated. Conventional sensors such as passive infrared, microwave, reflective infrared, reflective ultrasonic, vibrational may be accommodated individually or in combination. Typically, at least one motion sensor will be used. In addition, to proximity sensors image recognition software may be used for real-time analysis of an image feed from camera 46 to detect a presence of an event participant within a preset range.

Time limits may be set for any stage of operation. For example, if rotation stops to engage an event participant, the rotation may begin without proceeding to image capture if confirmation is not received from the participant within a preset time limit. Confirmations could be obtained in any convenient manner including voice commands or touch commands. Image capture includes both static and moving images (ie., photos and/or videos).

When videos are captured typically audio will also be captured. Furthermore, the processor 52 and the camera 46 and/or the microphone 48 may be configured to continuously capture data for quality control and/or security purposes. The continuous capture may be uploaded to a remote data storage system and saved for a predetermined period of time.

Any printer device may be incorporated including inkjet printers, laser printers, 3D printers, and the like. Many different printer types with various print substrates are available that provide entertainment value. For example, printers are available that can capture an image and extract faces from the captured image and process the facial image on a body of a desired professional sports player and print the processed image on a card that resembles a collectible sports card. Many other picture processing themes may be used including super hero themes, celebrity themes, movie themes, and the like.

Captured and processed images may be sent to event participants through any conventional electronic communication including email, text message, retrievable from a unique URL, posting to an event website, posting to a social media site and the like. Sending images through electronic communication may replace the printer function or may be used in conjunction with the printer function.

The interactive photo kiosk may be programmed to provide a humanized experience. The electronic monitor may display an avatar or character that engages event participants using voice prompts and responds to voice commands. The avatar may be programmed with context appropriate facial expressions. Additionally, with Internet connectivity an event participant that is unable to navigate the touch screen or voice command interface to achieve a successful result may be given an option to interact with a remote human operator, with the remote human operator communicating in a real time video chat and interjecting control of the engagement and image capture process.

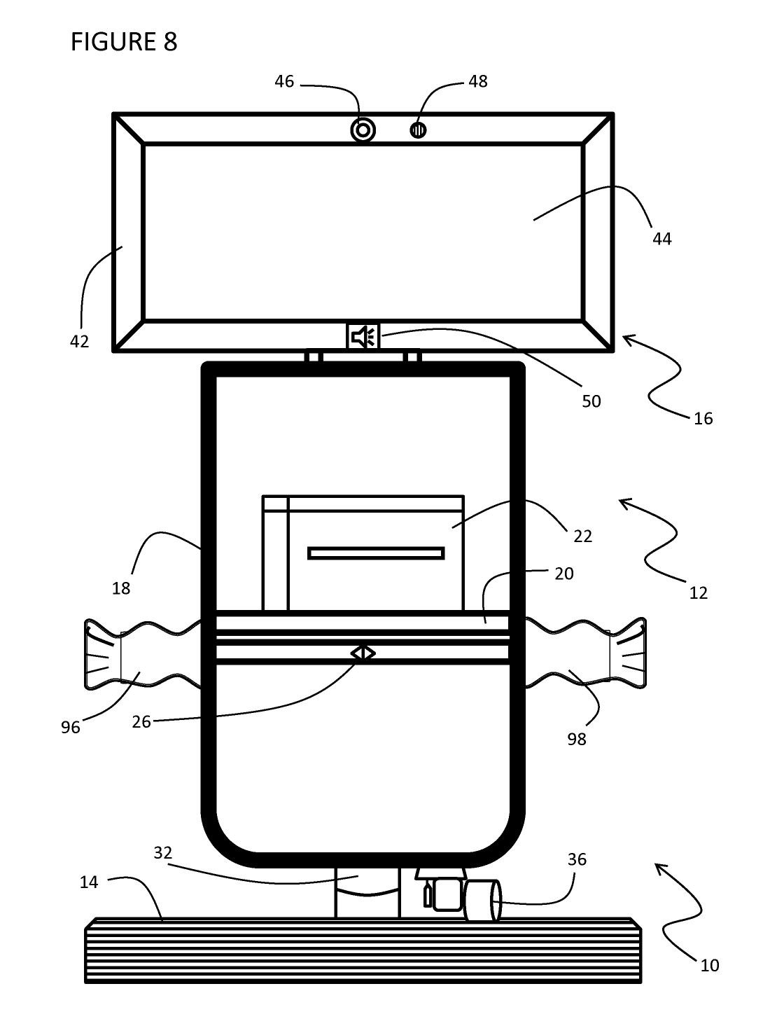

As a further humanizing element the interactive photo kiosk 10 may be equipped with arms as shown in FIG. 8. A first balloon arm 96 and a second balloon arm 98 are connected to first and second sides of frame 18 as shown in FIG. 8. Each balloon arm is communicative with a nozzle hosed within frame 18 with each nozzle being supplied with pressurized air by an air compressor and connective tubing. The air compressor may be controlled to supply air in bursts, continuously or in a continuous modulated manner as desired. Advantageously, air bursts may be provided in context appropriate manner to coordinate with specific stages of the engagement and image capture process. Additionally, each nozzle may be supported on a pivot joint with one degree of freedom, a dual axis gimbal joint with two degrees of freedom, a ball joint with three degrees of freedom, and the like to position the nozzle to direct air flow and the balloon arm in different directions: for example, horizontally outstretched to indicate a welcome or shake-hands gesture, or vertically outstretched to indicate congratulations or hi-five gesture. Arms need not be limited to pneumatic balloon arms and can include any other conventional arm such as mechanical arms with joints and rotational degree of freedom. Static arms or arms with limited motion such as vibrational arms or magnetic arms may also be used.

Photography lights 28 and 30 are optional and when included may be a single light or multiple lights. When included photography lights may be controlled by the processor to flash or blink to engage participants and/or to reward participants after a successful image capture. Photography lights may include any type of conventional lighting, for example, LED lights. LED lights may be configured in any convenient form including button lights or strip lights.

Remote centrally located network linked servers and/or human operators may assist, control or intervene with any part of the process of event participant engagement and image capture including lighting controls, motion controls, camera settings, image processing and the like.

The network may be a single network or a combination of multiple networks. For example, the network may include the internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. Typically, the network will comprise a computer network that makes use of a TCP/IP protocol (including protocols based on TCP/IP protocol, such as HTTP, HTTPS or FTP).

Communication between remote servers and interactive photo kiosks may be adapted to follow any computer communication standard including Extensible Markup Language (XML), Hypertext Transfer Protocol (HTTP), Java Message Service (JMS), Simple Object Access Protocol (SOAP), Lightweight Directory Access Protocol (LDAP), and the like.

The server computer may be any combination of hardware and software components used to store, process and/or provide images and actions for participant engagement, image capture, image processing and/or image delivery. The server computer components such as storage systems, processors, interface devices, input/output ports, bus connections, switches, routers, gateways and the like may be geographically centralized or distributed. The server computer may be a single server computer or any combination of multiple physical and/or virtual servers including for example, a web server, an image server, an application server, a bus server, an integration server, an overlay server, a meta actions server, and the like. The server computer components such as storage systems, processors, interface devices, input/output ports, bus connections, switches, routers, gateways and the like may be configured to run one or more applications to, for example, monitoring an oscillating rotation of a plurality of interactive photo kiosks, receiving a captured image and selections for image processing from at least one of the plurality of interactive photo kiosks, processing the captured image to generate a processed image, deliver the processed image to a designated event participant.

The interactive photo kiosk and networked systems incorporating the same may accommodate any type of still or moving image file including JPEG, PNG, GIF, PDF, RAW, BMP, TIFF, MP3, WAV, WMV, MOV, MPEG, AVI, FLV, WebM, 3GPP, SVI and the like. Furthermore, a still or moving image file may be converted to any other file without hampering the ability of the system software to identify and process the image. Thus, the system may accommodate any image file type and may function independent of a conversion from one file type to any other file type.

Parameters and selections for image capture and/or image processing may be represented by any convenient form or user interface element including, for example, a window, a tab, a text box, a button, a hyperlink, a drop down list, a list box, a check box, a radio button box, a cycle button, a datagrid or any combination thereof. Furthermore, the user interface elements may provide a graphic label such as any type of symbol or icon, a text label or any combination thereof. The user interface elements may be spatially anchored or centered around the corresponding image such that the user interface elements may appear at or near their corresponding image. Otherwise, any desired spatial pattern or timing pattern of appearance of user interface elements may be accommodated by the interactive photo kiosk or a networked system incorporating the same. Parameters or selections may be represented through visual and/or audio interface. Any combination of touch command, voice command or pointer commands may be accommodated. Any number of selected parameters and selections may be associated with each image capture and image processing, and each parameter or selection may be represented by one or more user interface elements as desired.

The interactive photo kiosk and networked systems incorporating the same as described herein and each variant, modification or combination thereof may also be implemented as a method or code on a non-transitory computer readable medium (i.e. a substrate). The computer readable medium is a data storage device that can store data, which can thereafter, be read by a computer system. Examples of a computer readable medium include read-only memory, random-access memory, CD-ROMs, magnetic tape, optical data storage devices and the like. The computer readable medium may be geographically localized or may be distributed over a network coupled computer system so that the computer readable code is stored and executed in a distributed fashion.

Directional terms such as vertical, horizontal, front, back, top and bottom are intended in the context of an installed and operational interactive photo kiosk.

Embodiments described herein are intended for illustrative purposes without any intended loss of generality. Still further variants, modifications and combinations thereof are contemplated and will be recognized by the person of skill in the art. Accordingly, the foregoing detailed description is not intended to limit scope, applicability, or configuration of claimed subject matter.

1. A portable interactive photo kiosk comprising:
a weighted base section comprising a bottom surface for abutting support on a floor surface and a top surface defining a bore for rotatably receiving a rotational shaft;
a body section housing a drive mechanism to control oscillating rotation of the body section relative to the base section between a first angular end position and a second angular end position;
a display comprising a processor and interactive touch screen display coupled to a top portion of the body section;
a camera communicative with the processor,
a printer housed within the body section and communicative with the processor; and
a proximity sensor communicative with the processor for sending a control signal to stop oscillating rotation of the body section.

2. (canceled)

3. (canceled)

4. (canceled)

5. (canceled)

6. The portable interactive photo kiosk of claim 1, wherein the drive mechanism comprises a motor and a drive shaft, the motor extends from a bottom surface of the body section, the drive shaft is substantially parallel to a top surface of the weighted base, and the drive shaft is coupled to a wheel that frictionally engages the top surface of the weighted base.

7. The portable interactive photo kiosk of claim 6, wherein mounting of the motor comprises resilient spacers to bias the wheel against the top surface of the weighted base.

8. (canceled)

9. (canceled)

10. (canceled)

11. The portable interactive photo kiosk of claim 1, wherein a range of oscillation is less than 180 degrees and wherein the range of oscillation further comprises a third angular position that is designated for image capture.

12. (canceled)

13. The portable interactive photo kiosk of claim 11, wherein the third angular position is outside the first and second angular end positions.

14. (canceled)

15. (canceled)

16. The portable interactive photo kiosk of claim 1, wherein the first and second angular end positions are controlled by at least one limit switch.

17. (canceled)

18. (canceled)

19. The portable interactive photo kiosk of claim 1, wherein the processor is communicative with a network access device.

20. The portable interactive photo kiosk of claim 1, further comprising first and second arms attached to and extending outward from opposing side surfaces of the body section.

21. The portable interactive photo kiosk of claim 20, wherein the first and second arms are mechanical or pneumatic.

22. (canceled)

23. (canceled)

24. The portable interactive photo kiosk of claim 16, wherein the top surface of the weighted base comprises at least two markers that interact with the at least one limit switch.

25. The portable interactive photo kiosk of claim 1, wherein the display shows a first set of images during oscillating rotation and a second set of images during a stop of oscillating rotation.

26. A system of networked interactive photo kiosks comprising:
a plurality of interactive photo kiosks, each interactive photo kiosk designated by a unique identifier and comprising:
a weighted base section comprising a bottom surface for abutting support on a floor surface;
a body section housing a drive mechanism to control oscillating rotation of the body section relative to the base section between a first angular end position and a second angular end position;
a display comprising a processor and an interactive touch screen display coupled to a top portion of the body section;
a camera communicative with the processor;
a sensor communicative with the drive mechanism for sending a control signal to stop oscillating rotation of the body section;
a network interface device communicative with the processor and a network; and
at least one remote server receiving image data and oscillating rotation data from the plurality of interactive photo kiosks over the network.

27. (canceled)

28. (canceled)

29. (canceled)

30. (canceled)

31. The system of claim 26, wherein the drive mechanism comprises a motor and a drive shaft, the motor extends from a bottom surface of the body section, the drive shaft is substantially parallel to a top surface of the weighted base, and the drive shaft is coupled to a wheel that frictionally engages the top surface of the weighted base.

32. The system of claim 31, wherein mounting of the motor comprises resilient spacers to bias the wheel against the top surface of the weighted base.

33. (canceled)

34. The system of claim 26, wherein a range of oscillation is monitored and adjusted by the at least one remote server.

35. The system of claim 26, wherein the at least one remote server is configured for manual override of a range of oscillation by a human operator.

36. The system of claim 34, wherein the range of oscillation further comprises a third angular position that is designated for image capture.

37. (canceled)

38. The system of claim 36, wherein the third angular position is outside the first and second angular end positions.

39. (canceled)

40. (canceled)

41. The system of claim 26, wherein the first and second angular end positions are controlled by at least one limit switch.

42. The system of claim 41, wherein the top surface of the weighted base comprises at least two markers that interact with the at least one limit switch.

43. The system of claim 26, wherein the display shows a first set of images during oscillating rotation and a second set of images during a stop of oscillating rotation.

44. (canceled)
